(19) United States
(12) Patent Application Publication
(10) Pub. No.: US 2007/0222311 A1
(43) Pub. Date: Sep. 27, 2007

(54) Rotating electrical Machine, in Particular Motor Vehicle Alternator, Whereof the Input/Outputs Comprise Fines Inclined Relative to the Fan Blades

(75) Inventor: Claudiu Vasilescu, Paris (FR)

Correspondence Address: MATTHEW R. JENKINS, ESQ., 2310 FAR HILLS BUILDING, DAYTON, OH, 45419, US

(73) Assignee: VALEO EQUIPEMENTS ELECTRIQUES MOTEUR, Creteil Cedex (FR)

(21) Appl. No.: 10/597,923

(22) PCT Filed: Mar. 25, 2005
(86) PCT No.: PCT/FR05/00715

§ 371 Date: Dec. 27, 2006

(30) Foreign Application Priority Data
Mar. 26, 2004 (FR) FR 04 03 173

(51) Int. Cl. H02K 9/00; H02K 9/06; H02K 3/24; H02K 11/04; H02K 5/00

(52) U.S. Cl. 310/58; 310/89; 310/64; 310/68 D; 310/62

(57) ABSTRACT

The invention concerns a rotating electrical machine comprising an outer shell, a stator, a rotor, and a fan with blades arranged on one first axial side of the rotor, the shell having on its outer periphery radial ports consisting of each of an opening subdivided by fins each elongated according to a particular profile of its own, at least one fin of at least one of the radial ports is inclined such that the edges of the blades facing said port sweep gradually across the fin according to its profile while rotating about the rotary shaft, in a shearing movement whereby each time only one substantially point-shaped portion of the edge of the blade is opposite the fin.

### BACKGROUND OF THE INVENTION

1. Field of the Invention

The invention concerns in general terms rotating electrical machines, in particular motor vehicle alternators.

2. Description of the Related Art

Machines of this type are known in the prior art, and typically comprise cylindrical radial outlet ports whereof the fins have the form of strips extending in respective radial planes.

They are particularly noisy when they are equipped with fans whereof the blades also extend in radial planes and which are moving in front of the fixed obstacles formed by these fins.

There is therefore a need to provide an alternator that overcomes the noise problems of the prior art.

### SUMMARY OF THE INVENTION

In this context, the aim of the present invention is to overcome the failing mentioned above and propose a particularly silent machine.

More precisely, the invention concerns a rotating electrical machine, in particular a motor vehicle alternator, comprising a longitudinal axis, an outer shell of hollow form, a stator fixed in the shell, a rotary shaft passing through the stator along the longitudinal axis, a rotor fixed to the shaft rotating inside the stator, and a fan with blades driven rotationally by the shaft and disposed on a first axial side of the rotor inside the shell, this shell having, on the one hand, at its outer periphery, radial ports and, on the other hand, at at least one of its axial ends, axial ports for constituting air inlet and air outlet ports arranged so that the fan creates a flux of air going from inlet to outlet, the inlet and outlet ports each consisting of an opening cut in the shell and subdivided by mechanical supporting fins each elongated according to a profile specific thereto.

To this end, the machine of the invention, in other respects conforming to the generic definition given thereof by the preamble above, in which a radial port is made on a radial face, overall of longitudinal orientation, of the shell and has a substantially cylindrical overall shape coaxial with the longitudinal axis, is essentially characterized in that at least one fin, referred to as a radial fin, of said radial port, considered in the plane tangential to this port at the level of said radial fin, extends in a general direction forming an angle greater than 0° with respect to the longitudinal direction so that edges of the fan blades turned towards said port progressively sweep across the radial fin according to its profile while turning about the rotary shaft, in a shearing movement whereby at each instant only one substantially point-shaped portion of the edge of the blade is opposite the fin.

By virtue of one embodiment of the invention, the noise and pressure drops are reduced.

More precisely, the shocks between the cooling fluid, such as air, and the radial fin are reduced.

The flow of the cooling fluid, such as air, is stabilized, with greater throughput.

The vibration effects due to turbulence are reduced.

The efficiency of the fan is therefore improved.

Moreover, when the radial port is an outlet port, the risks of detachment of the stream of cooling fluid, such as air, with respect to the radial fins is reduced. The flow of the cooling fluid is stabilized.

The formation of eddies between the radial fins is limited by making movement of the cooling fluid in the backward direction in the direction of the winding overhangs of the stator of the machine difficult, perhaps even impossible, which allows better removal of heat.

In one possible embodiment of the invention, the angle is advantageously less than 30°.

This angle makes it possible to further improve the efficiency of the fan.

In one possible embodiment of the invention, the radial inlet or outlet port can comprise at least one radial fin which, considered in cross-section in a plane perpendicular to the longitudinal axis, is inclined with respect to the radial direction in order to further improve the throughput of the cooling fluid and reduce the noise still further.

Furthermore, an axial air inlet or outlet port can be made on an axial face of the outer shell, overall of orientation perpendicular to the longitudinal axis, and be delimited on a radially inner side by a substantially circular inner edge, at least one fin, referred to as an axial fin, of said port, considered in a plane perpendicular to the longitudinal axis, extending in a general direction forming an angle less than 90° with respect to the tangent to the inner edge passing through said fin.

In this case, the angle is preferably greater than 60°.

The axial fin is preferably inclined in the direction of rotation of the fan in order to further reduce the pressure drops and facilitate even more the flow of the cooling fluid, such as air.

In an advantageous embodiment, the radial port comprises at least one radial fin which, considered in cross-section in a plane perpendicular to the longitudinal axis, is inclined with respect to the radial direction, whilst the axial fin, considered in cross-section in a plane perpendicular to the longitudinal axis, is inclined with respect to the radial direction in the same sense as the radial fin.

By virtue of this provision, better reduction of the noise as well as very good circulation of the cooling flux such as air is obtained. Thus the flow of cooling fluid is stabilized with even greater throughput and less noise. The turbulence in the cooling flux passing through the shell is reduced still further.

Advantageously, the radial ports are outlet ports and the axial ports are inlet ports in the case where the shell includes electronic means.

In general terms, the fan for example can be of axial, centrifugal, helico-centrifugal, centripetal or helico-centripetal type, so that the ports can be air outlet or inlet ports.

Advantageously, the machine can comprise a second fan with blades driven rotationally by the shaft and disposed on a second axial side of the rotor opposite to the first inside the shell, this shell having second air inlet and air outlet ports arranged so that the second fan creates a flux of air going from inlet to outlet, the second inlet and outlet ports each consisting of an opening cut in the shell and subdivided by mechanical supporting fins each elongated according to a profile specific thereto, at least one fin of at least one of the second inlet and/or outlet ports being inclined so that edges of the blades of the second fan turned towards said port progressively sweep across the fin according to its profile while turning about the rotary shaft, in a shearing movement whereby at each instant only a substantially point-shaped portion of the fin is opposite the edge of the blade.

The machine can also have one or more of the following characteristics.
The fins have, perpendicular to their profile, a section of constant size.
The fins have, perpendicular to their profile, a section of variable size along this profile in order to further reduce the aerodynamic resistance.
The fins have, perpendicular to their profile, a rectangular section.
The fins have, perpendicular to their profile, a round section.
The fins have, perpendicular to their profile, an elliptical section.
The fins have, perpendicular to their profile, a shaped section relatively thicker on a radially inner side and relatively thinner on a radially outer side in order to further reduce the aerodynamic resistance.
The fins have a straight profile.
The fins have a curved profile.
At least one of the fins of at least one of the inlet and outlet ports has an edge turned towards the fan inclined so that the edges of the blades turned towards said port progressively sweep across said edge of the fin while turning about the rotary shaft, in order to further increase the throughput and further reduce the noise.

All these aforementioned characteristics are to be considered individually and/or in combination.

By virtue of the invention, the throughput of the cooling fluid, such as air, can be increased without increasing the noise.

These and other objects and advantages of the invention will be apparent from the following description, the accompanying drawings and the appended claims.

### BRIEF DESCRIPTION OF THE ACCOMPANYING DRAWINGS

Other characteristics and advantages of the invention will emerge clearly from the description thereof given below, as an illustration and in no way limiting, with reference to the accompanying figures, amongst which:

FIG. 1 is a half-view in longitudinal cross-section of a rotating electrical machine according to the invention;

FIG. 2 is a partial view in perspective of the machine of FIG. 1, showing the respective positions of the blades of the fan and the fins of the air outlet;

FIG. 3 is a side view in a centripetal radial direction, along the arrow III of FIG. 2;

FIG. 4 is an axial view along the arrow IV of FIG. 1, showing the respective positions of the blades of the fan and the fins of the air inlet;

FIG. 5 is a view similar to that of FIG. 3, for a variant implementation in which the fins are curved; and

FIG. 6 is a partial view in cross-section in a plane perpendicular to the longitudinal axis, marked by the arrows VI of FIG. 1.

### DETAILED DESCRIPTION OF THE PREFERRED EMBODIMENTS

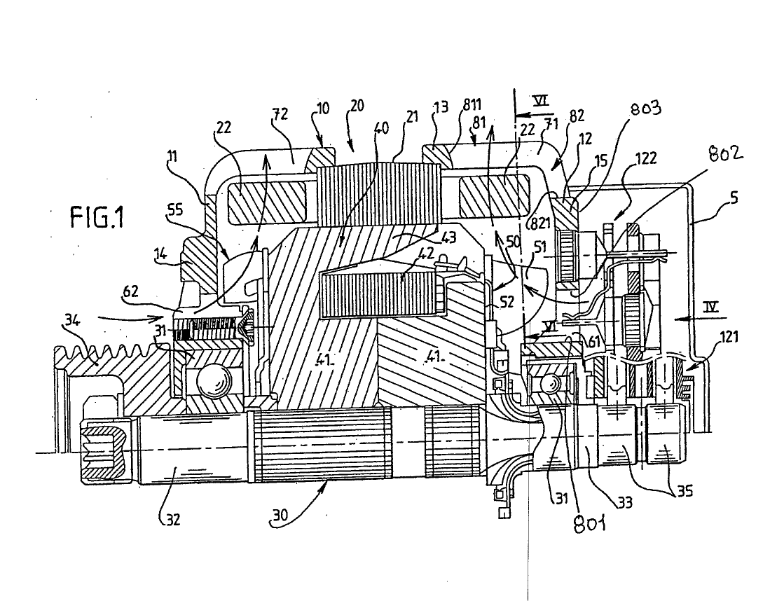

The rotating electrical machine depicted in FIG. 1 is a polyphase motor vehicle alternator with internal ventilation, comprising an outer shell 10 of hollow form, a stator 20 fixed in the shell 10, a rotary shaft 30 passing through the stator 20 along a longitudinal axis, and a rotor 40 fixed to the shaft 30 rotating inside the stator 20. The axis of the shaft 30 defines the longitudinal axis.

The stator 20 typically comprises a cylindrical body coaxial with the longitudinal axis, formed from laminations 21, on the radially inner face of which there are made a series of slots passing through axially, extending in respective radial planes, and phase windings disposed inside the slots and forming on the two opposite axial sides of the laminations 21 stator winding overhangs 22 extending substantially axially in line with the laminations 21. The alternator is considered to comprise at least one winding per phase. The windings can be of the type with separate coils, with interlocking coils or of the type with bars for example U-shaped as described in the document WO 92/06527, which is incorporated herein by reference and made a part hereof.

The rotor 40 comprises two claw magnet wheels 41 and a field winding 42 disposed between the magnet wheels 41. Each magnet wheel 41 comprises a flange extending substantially perpendicular to the longitudinal axis, having at its periphery axially oriented teeth 43 directed towards the flange of the other magnet wheel. The teeth of the two wheels are circumferentially offset and interpenetrate, so that, along the circumference of the rotor, teeth belonging to the two wheels are found alternately. These teeth each have an overall trapezoidal shape, and point towards the opposite magnet wheel.

The flanges each have a central bore going through them receiving the rotary shaft 30, and are fixed to this shaft rotation-wise by ribs, such as knurling, cooperating with grooves made in the shaft 30.

The winding 42 is disposed under the teeth 43, that is to say on a radially inner side thereof, and is wound around a core. The core is inserted axially between the two flanges of the magnet wheels 41, 42. In one embodiment, this core is distinct from the flanges of the magnet wheels 41, 42. In a variant, as depicted in FIG. 1, the core is made from two parts, each part originating from one of the flanges. The wheels and the core are preferably made from ferromagnetic material. When the winding 42 is supplied electrically, the teeth of one of the magnet wheels 41 define north poles, whilst the teeth of the other magnet wheel 42 define south poles.

The rotor 40 turns inside the stator 20, a given air gap separating the radially outer face of the rotor 40, defined by the teeth 43, from the inner face of the stator, defined by the laminations 21.

The shell 10, forming a housing, is intended to be fixed on the vehicle and has a cylindrical overall shape coaxial with the longitudinal axis. This shell is preferably made from moldable material. It is made for example from aluminum, or an alloy comprising aluminum. It is divided along a median plane perpendicular to the longitudinal axis into two cylindrical parts referred to as front and rear end plates 11 and 12 of hollow form, each comprising a radial face 13 substantially of longitudinal orientation and an axial face 14, 15 substantially perpendicular to the longitudinal axis, closing the radial face on one side, the other side of the radial face remaining open.

In FIG. 1 the radial 13 and axial 14, 15 faces are respectively of longitudinal orientation and of orientation perpendicular to the longitudinal axis. In a variant, the radial and axial faces can be inclined so that each end plate 11, 12 comprises at its outer periphery a radial face substantially of longitudinal orientation and at one of its axial ends an axial face substantially of orientation perpendicular to the longitudinal axis.

The front and rear end plates 11 and 12 are applied onto the body 21 of the stator by the open sides of their respective radial faces and fixed to one another, for example by tie rods, not depicted, the axial faces of the front and rear end plates 11 and 12 thus constituting respectively the front and rear axial faces 14 and 15 of the outer shell 10.

In variants, the end plates 11, 12 are applied one on the other by the open sides of their radial faces.

The front and rear axial faces 14 and 15 have respective central openings passing through them, each receiving a ball bearing 31, these bearings supporting front and rear end parts 32 and 33 of the shaft 30.

The front end part 32 is continued axially beyond the front axial face 14, in order to carry a movement transmission member 34 in the form of a pulley, which is fixed onto this part outside the shell 10 and is fixed rotation-wise to the shaft 30, here by means of a nut (not referenced) mounted on the threaded end of the front end 32. Thus the pulley is intended to cooperate with a belt with V-shaped grooves (not depicted) by means of which the heat engine of the motor vehicle drives the shaft 30 and the rotor assembly 40 when the electrical machine, here the alternator, is working in electrical generator mode in order in particular to recharge the vehicle battery and power the consumers on the on-board electrical network of the vehicle.

In a variant, the alternator is reversible and works in generator mode, as mentioned above, and in electric motor mode.

This pulley and the belt associated therewith in this case also in the reverse direction allow the electrical machine to drive the heat engine, when said machine is working in starter mode in order in particular to start the heat engine. Such a reversible alternator is referred to as an alternator starter and is described in more detail for example in the document WO 01/69762 to which reference should be made for further information. The movement transmission between the shaft 30 and the heat engine of the vehicle in a variant can comprise gears, at least one chain of pulleys with variable spacing, and/or at least one belt. Thus, the movement transmission member 34 can have many configurations and consist of a gear, a toothed wheel, a pulley, etc.

The rear end part 33 of the shaft 30 carries collars 35 connected by wire links to the ends of the winding 42, these collars being disposed outside the shell 10. The rear end plate 12 carries on an outer side of the shell 10 a brush holder member 121 carrying brushes cooperating with the collars 35, a voltage regulator connected to the winding 42 via the brushes of the brush holder 121 and electronic means 122 for rectifying the alternating current produced by the alternator and controlling the machine. These means typically comprise the voltage regulator for controlling the field winding of the machine and a bridge rectifying the alternating current produced by the stator. This bridge is connected to the phase windings of the stator and is for example a diode bridge, two of these diodes mounted head-to-tail being visible in FIG. 1, or a MOSFET type transistor bridge in the case of an alternator starter. Also provided are terminals for connecting to the electrical circuit of the vehicle, at least one of these terminals being for example carried by the electronic means 122. The diode bridge here comprises at least six diodes on the basis of at least three diodes, referred to as negative diodes, carried by the rear end plate and at least three diodes, referred to as positive diodes, carried by a heat sink.

In a variant the bridge can comprise twelve diodes as described in the document WO 03/009452 to which reference should be made.

The machine also comprises a perforated cover 5, for example made of plastic, fixed on the rear end plate 12 on an outer side of the rear axial face 15 of the shell 10, and covering the brush holder member 121 and the voltage regulator as well as the rectifier bridge of the electronic means 122.

Of course, in a variant, the rectifier bridge and/or the voltage regulator of the electronic means 122 are mounted in an outer casing connected by a connecting device to the rotating electrical machine.

The shell 10 has on a first axial side of the rotor 40, for example on the rear side, at least one axial port 61 made in the rear axial face 15, and at least one radial port 71 made in the radial face 13 of the rear end plate 12. The ports 61, 71 are made respectively at one of the axial ends of the shell and at the outer periphery of the shell in the manner described hereinafter.

The machine also comprises, for example on the rear side, a fan 50 with blades 51 driven rotationally by the shaft 30 and disposed on the first axial side of the rotor 40 inside the shell 10.

Similarly, the shell 10 has on a second axial side of the rotor 40, for example on the front side, at least one second axial port 62 made in the front axial face 14, and at least one second radial port 72 made in the radial face 13 of the front end plate 11.

The machine further comprises a second fan 55 with blades driven rotationally by the shaft 30 and disposed on the second axial side of the rotor 40 inside the shell 10.

The fans 50, 55 are fixed to the rotor for example by weld points or by crimping.

In this embodiment the shell has several axial and radial ports that are respectively air inlet and outlet ports.

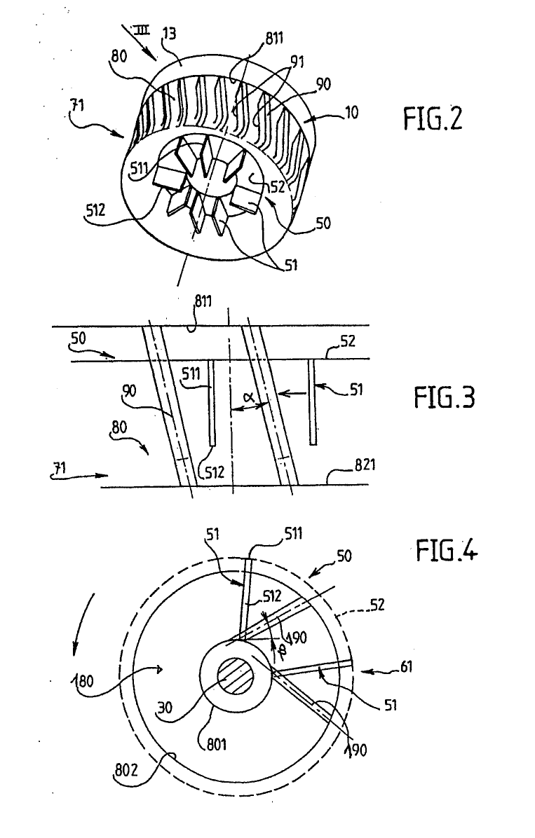

The air inlet axial ports 61/62 and air outlet radial ports 71/72 (FIG. 2) each consist of an opening respectively 180, 80 cut in the shell 10 and subdivided by fins respectively 190, 90 each elongated according to a profile specific thereto.

Profile of a fin 190, 90 therefore refers to the shape this fin 90 forms when it is followed over its longest length.

It should be noted that the number of radial ports is greater than the number of axial ports.

In a plane perpendicular to its profile, each radial fin 90 has a section of small dimensions compared with its length along its profile.

The openings 180 of the axial ports 61/62, substantially perpendicular to the longitudinal axis (FIGS. 1 and 4), each favorably has the overall shape of a sector of a ring centered on the longitudinal axis and surrounding the bearing 31, and is delimited by inner and outer circular edges 801 and 802.

The fins 190 connect the edges 801, 802 to one another. For simplicity not all the fins 190 have been depicted in FIG. 4.

The edge 801 delimits the outer periphery of a sleeve delimiting a housing for mounting the bearing 31 concerned of FIG. 1. This sleeve is not referenced in FIG. 1.

The edge 802 delimits the inner periphery of an area 803 affected at its outer periphery by the openings 80 of the radial ports 72/71.

In FIG. 1 this area 803 is an area for mounting the diodes of the rectifier bridge here press-fitted into the axial face 15 of the rear end plate 12. In a variant, these diodes are soldered onto the axial face 15.

The openings 80 of the radial ports 72/71 (FIGS. 1 to 3), overall of longitudinal orientation, have a general cylindrical shape of revolution about the longitudinal axis, comprising a cylindrical part 81 constituting respectively the front or rear end of the radial face 13, continued by an annular part 82 constituting the outer edge respectively of the front and rear axial faces 14/15. The part 82 makes it possible to obtain the ports 72/71 by stripping and affects the area 803.

The cylindrical parts 81 extend opposite the winding overhangs 22 of the stator 20 and are delimited on the median plane side of the shell 10 by respective central circular edges 811 adjacent to the laminations 21. The annular parts 82 are delimited on a radially inner side by respective lateral circular edges 821. The parts 82 are overall perpendicular to the longitudinal axis.

The fins 90 of the same radial port have the same general shape, and are favorably regularly spaced apart at the outer periphery of the shell 10, locally dividing it into a plurality of openings 80 in the form of sectors of the same general shape (FIG. 2).

The same applies for the fins 190.

The radial fins 90 of the radial ports 71/72 are each fixed by one end to the central edge 811, here delimiting a strip of material that extends to the open free end of the axial face 13, and by the opposite end to the lateral edge 821 belonging to the axial face 14/15. The axial fins 190 of the axial ports are, in the aforementioned manner, each fixed by one end to the inner circular edge 801 and by the opposite end to the outer circular edge 802.

These fins 90, 190 have both a function of mechanical connection between different parts of the end plate, and a function of dissipating thermal energy emitted by the machine during operation.

The fans 50/55 each comprise a hub 52 typically extending in a plane perpendicular to the longitudinal axis, this hub 52 typically being flattened and fixed, for example by weld points, onto the flange of the magnet wheel 41 situated on the corresponding axial side, respectively the rear and front sides. The hub 52 can be solid or cut.

The blades 51 of the fans 50/55 are thin webs, extending axially from the hub 52 respectively towards the rear and towards the front.

In an example implementation, the fans 50/55 are centrifugal and the blades 51 are disposed in radial planes and regularly distributed angularly about the longitudinal axis. They can for example each have an overall rectangular shape, delimited on a radially outer side by an axial straight outer edge 511 turned towards the radial port 71/72, and on a front or rear axial side by a straight radial edge 512 turned towards the axial port 62/61.

When the rotor 40 is driven rotationally by the shaft 30, the fans 50/55 create currents of cooling fluid, here air, inside the shell 10, represented by arrows in FIG. 1.

In general, for simplicity the cooling fluid will be referred to as air.

The air enters axially through the axial ports 61/62 serving as air inlets, is propelled radially through the winding overhangs 22, and leaves the shell 10 through the radial ports 71/72 serving as air outlets.

According to one characteristic of the invention, at least one radial fin 90 of at least one of the radial ports is inclined so that edges of the blades 51 turned towards said port progressively sweep across the fin 90 according to its profile while turning about the rotary shaft 30, in a shearing movement whereby at each instant only a substantially point-shaped portion of the edge of the blade 51 is opposite the fin 90.

The same applies preferably as regards the axial fins 190 of at least one of the axial ports, which is inclined so that edges of the blades 51 turned towards said port progressively sweep across the fin 190 according to its profile while turning about the rotary shaft 30, in a shearing movement whereby at each instant only a substantially point-shaped portion of the edge of the blade 51 is opposite the fin 190.

In a variant, the axial fin 190 is not inclined.

Preferably, all the radial fins 90 and axial fins 190 of all the air inlets and outlets are inclined.

In one embodiment, the fins 90, 190 are inclined in the opposite sense considering the direction of rotation of the fan concerned.

Preferably, according to one characteristic the fins 90, 190 are inclined in the same sense as the direction of rotation of the fan.

Thus, in a plane perpendicular to its profile, each radial fin 90 has a section of small dimension compared with its length along its profile; this section belongs to an axial part, referred to hereinafter as a cross-head, inclined circumferentially in the same sense as an axial fin 190.

According therefore to one characteristic the radial port (71) comprises at least one radial fin 90 which, considered in cross-section in a plane perpendicular to the longitudinal axis, is inclined with respect to the radial direction. The axial port 61 comprises at least one axial fin 190 which, considered in cross-section in a plane perpendicular to the longitudinal axis, is inclined with respect to the radial direction in the same sense as the radial fin 90.

A description will first be given of a first example implementation in which the fins 90, 190 are substantially straight, corresponding to FIGS. 2 to 4.

As can be seen in FIG. 2, the radial fins 90 of the radial port 71 each have a profile consisting of a straight portion extending in the cylindrical part 81 of the opening 80, and a cross-head continuing the straight portion and extending in the annular part 82.

The straight portion is not parallel to the longitudinal axis, but on the contrary extends in a direction inclined with respect to this axis.

As can be seen in FIG. 3, each radial fin 90 of the radial port 71, considered in the plane tangential to said port 71 at the level of said fin, extends in a general direction that is specific thereto. In the example implementation illustrated here, this general direction is a straight line inclined with respect to the longitudinal axis, corresponding to the direction in which the first portion of the fin 90 extends. This general direction forms an angle α greater than 0° with respect to the longitudinal direction.

In a preferred embodiment, the angle α is less than 30°, the optimum being achieved for an angle of the order of 15°.

Such an angle allows the fins to fulfill highly satisfactorily their function of mechanical connection between the radial and axial faces of the end plates, whilst significantly reducing the noise related to the rotation of the fan.

It can be seen clearly in FIG. 3 that, on account of the different orientations of the blade 51 and the fin 90, only a very short portion of the outer edge 511 of the blade 51 is opposite an inner edge 91 of the fin 90 at each instant. Said portion varies while the blade 51 is turning. In the example implementation illustrated in FIG. 3, it is first a rear end portion of the outer edge 511 that is situated opposite a central part of the fin 90. When the blade 51 turns, said portion moves towards the front, this portion progressively being situated opposite a part of the inner edge 91 of the fin 90 which shifts towards the front.

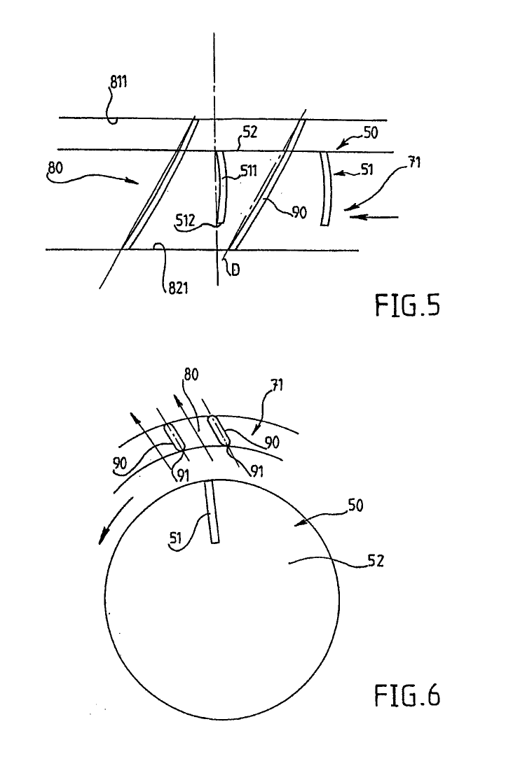

It should be noted that the fin 90 can be inclined equally well either, as in FIG. 3, so that the blade 51 moves from the rear towards the front along the fin 90, or in the opposite sense, so that the blade moves from the front towards the rear along the fin 90, as illustrated in FIG. 5.

Furthermore, the fins 90 typically have sections perpendicular to their profiles elongated in a substantially radial main direction. In a variant implementation illustrated in FIG. 6, this main direction is inclined with respect to the radial direction, with an angle adapted so that said main direction is parallel to the air flux passing through the radial port 71.

As can be seen in FIG. 4, the fins 190 of the axial port 61 each have a straight profile.

This profile is not radial, but on the contrary extends in a direction inclined with respect to the radial direction.

Considered in a plane perpendicular to the longitudinal axis, these fins 90 extend in a general direction forming an angle β less than 90° with respect to the tangent to the inner edge 801 passing through the end of said fin 90 fixed to said edge 801.

In a preferred embodiment, the angle β will be greater than 60°, the optimum being achieved for an angle β of the order of 70°.

Such an angle allows the fins to fulfill highly satisfactorily their function of mechanical connection between the radially inner and outer parts of the axial faces, whilst significantly reducing the noise related to the rotation of the fan.

It can be seen clearly in FIG. 4 that, on account of the different orientations of the blade 51 and the fin 90, only a very short portion of the radial edge 512 of the blade 51 is opposite the edge of the fin 90 turned towards the fan at each instant. Said portion varies while the blade 51 is turning. In the example implementation illustrated in FIG. 4, it is first an outer portion of the radial edge 512 that is situated opposite the end of the fin 90 fixed to the outer circular edge 802. When the blade 51 turns, said portion moves towards the inside, this portion progressively being situated opposite a part of the edge of the fin 90 which shifts towards the inside.

It should be noted that the fin 190 can be inclined equally well either, as in FIG. 4, so that the blade 51 moves from the outside towards the inside along the fin 90, or in the opposite sense, so that the blade moves from the inside towards the outside along the fin 90.

A description will now be given of a second example implementation in which the fins 90 of the radial port 71 have curved profiles, with reference to FIG. 5. Only the points that differ from the first example implementation will be detailed.

Each fin 90 of the radial port 71, considered in the plane tangential to said port 71 at the level of said fin, has a profile of curved shape, in an arc of a circle elongated in a first given general direction that is specific thereto, with concavity turned on the circumferential side towards which the blades 51 move. The concavity could also be turned on the opposite circumferential side. In the example implementation illustrated here, the first general direction is a straight line D inclined with respect to the longitudinal axis, marked in FIG. 5, and corresponding substantially to the straight line passing through the two opposite ends by which the fin 90 is attached to the central circular edge 811 and to the lateral circular edge 821.

This first general direction forms, with respect to the longitudinal axis, an angle a greater than 0°, preferably less than 30°, 15° constituting an optimum.

The inner edge of the fin 90 follows a curve substantially parallel to the profile of said fin.

As described previously, the fin 90 with a curved profile can also have, perpendicular to its profile, an inclined section.

The fins 190 of the axial ports 61/62 can also have curved profiles.

It should be noted that the blades 51 do not have to extend in radial planes, but instead in planes inclined with respect to the radial planes, or perhaps even have curved shapes. In these cases, the edges of the blades turned towards the fins can respectively be oblique or curved. The fins are then arranged so that these oblique or curved edges progressively pass along the fin according to its profile, as explained above.

The fins 90, 190 of the inlet and outlet ports can also have sections of variable sizes along their profile. These sections can for example be relatively larger on a radially inner side and relatively smaller on a radially outer side for the axial ports 61/62.

A description has been given above of the fins 90, 190 whereof the profile was straight or in an arc of a circle. The fins can have other shapes of profile, forming for example waves, or consisting of several straight-line segments with different inclinations, or any other possible shape different from a straight line parallel to the axis of rotation.

The fins 90, 190 can also extend in a curved surface, for example a portion of an ellipsoid or a portion of another quadric surface.

The edge of the fin turned towards the fan then does not have to be parallel to the profile of the fin. In this case an attempt will be made to obtain that the edge of the fin and its profile are both inclined with respect to the edges of the blades turned towards the fins.

The fan of the machine described above does not have to be centrifugal, but instead of helico-centrifugal, axial, centripetal or helico-centripetal type.

In the case of a helico-centrifugal fan, the axial port constitutes the air inlet, and the radial port is offset axially with respect to the fan towards the side of the machine opposite to the inlet port and constitutes the outlet port. The air flux passing through the outlet port forms an angle lying between 0° and 90° with respect to the longitudinal axis.

In the case of an axial fan, the axial port constitutes the air inlet, the shell not comprising any radial port but comprising another axial port on the side opposite to the first constituting the air outlet.

The fan can also be centripetal or helico-centripetal, in which case the shell comprises a radial port constituting the air inlet and an axial port constituting the air outlet. The radial port is situated axially substantially at the same level as the fan in the case of a centripetal fan, and is offset axially towards the side opposite to the axial port in the case of a helico-centripetal fan.

It can therefore be clearly understood that the machine described above has many advantages.

On account of the blades progressively sweeping across the fins according to the profiles of these fins, the noise generated by the crossing of a given blade and a given fin is greatly reduced. This noise is much greater when the blade is presented parallel to the fin.

The invention applies to all types and shapes of blade, and to all types and shapes of fin. The blades can be disposed in radial planes or not, and have flat or curved shapes. The fins can have straight or curved profiles, or inclined sections in a plane perpendicular to their profile.

It applies to machines equipped with all types of fan, either centrifugal, helico-centrifugal, axial, centripetal or helico-centripetal.

The blades of these fans can have outer edges 511 inclined with respect to the longitudinal axis. They can also have edges 512 turned towards the front or the rear which are non-radial, concave, convex, S-shaped, or others. The blades can be distributed angularly in a non-regular manner about the axis of rotation, and non-symmetrically with respect to a plane containing this axis.

Finally, the axial ports 71/72 can be made on axial faces 14/15 that are not perpendicular to the longitudinal axis, for example inclined by an angle less than 90° with respect to this axis, or on slightly curved axial faces, for example in a portion of a sphere.

The invention also applies to machines comprising a salient-pole rotor. In a variant the machine comprises a rotor with salient poles alternating with permanent magnets as described in the document WO 02/0545566.

The rear fan 51, more powerful than the front fan 51, can be a double fan comprising two series of blades as described for example in the document WO 2004/106748. This is made possible since by virtue of the invention the throughput of cooling air passing through the shell 10 can be increased without increasing the noise.

The presence of the front fan is not obligatory.

One of the end plates 11, 12 can have a chamber for the circulation of a cooling fluid, such as the cooling fluid for the heat engine of the vehicle.

The shell 10 can comprise more than two parts. For example the end plates 11, 12 can be mounted either side of a central part having internally the stator laminations. This central part can have a cooling chamber.

The openings 80, 180 of the radial or axial ports do not have to have a symmetry of revolution about the shaft 30, but instead have an oblong shape elongated in a given radial direction.

While the method herein described, and the form of apparatus for carrying this method into effect, constitute preferred embodiments of this invention, it is to be understood that the invention is not limited to this precise method and form of apparatus, and that changes may be made in either without departing from the scope of the invention, which is defined in the appended claims.

What is claimed is:

1. A rotating electrical machine, comprising a longitudinal axis, an outer shell of hollow form, a stator fixed in the shell, a rotary shaft passing through the stator along the longitudinal axis, a rotor fixed to the shaft rotating inside the stator, and a fan with blades driven rotationally by the shaft and disposed on a first axial side of the rotor inside said outer shell, said outer shell having, on the one hand, at its outer periphery, radial ports and, on the other hand, at least one of its axial ends, axial ports for constituting air inlet and air outlet ports arranged so that the fan creates a flux of air going from said air inlet to said air outlet, said air inlet and outlet ports each consisting of an opening cut in the shell and subdivided by mechanical supporting fins each elongated according to a profile specific thereto, in which a radial port is made on a radial face, overall of longitudinal orientation, of the shell and has a substantially cylindrical overall shape coaxial with the longitudinal axis, characterized in that at least one fin, referred to as a radial fin, of said radial port, considered in the plane tangential to this port at the level of said radial fin, extends in a general direction forming an angle greater than 0° with respect to the longitudinal direction so that edges of the fan blades turned towards said port progressively sweep across the radial fin according to its profile while turning about the rotary shaft, in a shearing movement whereby at each instant only one substantially point-shaped portion of the edge of the blade is opposite the fin.

2. The rotating electrical machine according to claim 1, characterized in that the angle is less than 30°.

3. The rotating electrical machine according to claim 1, characterized in that the radial port comprises at least one radial fin which, considered in cross-section in a plane perpendicular to the longitudinal axis, is inclined with respect to the radial direction.

4. The rotating electrical machine according to claim 1, characterized in that at least one axial port is made on an axial face of the outer shell, overall of orientation perpendicular to the longitudinal axis, and is delimited on a radially inner side by a substantially circular inner edge, at least one fin, referred to as an axial fin, of said port, considered in a plane perpendicular to the longitudinal axis, extending in a general direction forming an angle less than 90° with respect to the tangent to the inner edge so that said axial fin, considered in cross-section in a plane perpendicular to the longitudinal axis, is inclined with respect to the radial direction.

5. The rotating electrical machine according to claim 4, characterized in that the angle is greater than 60°.

6. The rotating electrical machine according to claim 4, characterized in that the radial port comprises at least one radial fin which, considered in cross-section in a plane perpendicular to the longitudinal axis, is inclined with respect to the radial direction, and in that the axial fin, considered in cross-section in a plane perpendicular to the longitudinal axis, is inclined with respect to the radial direction in the same sense as the radial fin.

7. The rotating electrical machine according to claim 1, characterized in that the radial fins have, perpendicular to their profile, a section of constant size.

8. The rotating electrical machine according to claim 1, characterized in that the radial fins have, perpendicular to their profile, a section of variable size along this profile.

9. The rotating electrical machine according to claim 8, characterized in that the fins have a curved profile.

10. The rotating electrical machine according to claim 1, characterized in that at least one of the fins of at least one of the axial and radial ports has an edge turned towards the fan inclined so that the edges of the blades of the fan turned towards said port progressively sweep across said edge of the fin while turning about the rotary shaft.

11. An alternator for use in a vehicle, said alternator comprising a longitudinal axis, an outer shell of hollow form, a stator fixed in the shell, a rotary shaft passing through the stator along the longitudinal axis, a rotor fixed to the shaft rotating inside the stator, and a fan with blades driven rotationally by the shaft and disposed on a first axial side of the rotor inside said outer shell, said outer shell having, on the one hand, at its outer periphery, radial ports and, on the other hand, at least one of its axial ends, axial ports for constituting air inlet and air outlet ports arranged so that the fan creates a flux of air going from said air inlet to said air outlet, said air inlet and outlet ports each consisting of an opening cut in the shell and subdivided by mechanical supporting fins each elongated according to a profile specific thereto, in which a radial port is made on a radial face, overall of longitudinal orientation, of the shell and has a substantially cylindrical overall shape coaxial with the longitudinal axis, characterized in that at least one fin, referred to as a radial fin, of said radial port, considered in the plane tangential to this port at the level of said radial fin, extends in a general direction forming an angle greater than 0° with respect to the longitudinal direction so that edges of the fan blades turned towards said port progressively sweep across the radial fin according to its profile while turning about the rotary shaft, in a shearing movement whereby at each instant only one substantially point-shaped portion of the edge of the blade is opposite the fin.

12. The alternator according to claim 11, characterized in that the angle is less than 30°.

13. The alternator according to claim 11, characterized in that the radial port comprises at least one radial fin which, considered in cross-section in a plane perpendicular to the longitudinal axis, is inclined with respect to the radial direction.

14. The alternator according to claim 11, characterized in that at least one axial port is made on an axial face of the outer shell, overall of orientation perpendicular to the longitudinal axis, and is delimited on a radially inner side by a substantially circular inner edge, at least one fin, referred to as an axial fin, of said port, considered in a plane perpendicular to the longitudinal axis, extending in a general direction forming an angle less than 90° with respect to the tangent to the inner edge so that said axial fin, considered in cross-section in a plane perpendicular to the longitudinal axis, is inclined with respect to the radial direction.

15. The alternator according to claim 14, characterized in that the angle is greater than 60°.

16. The alternator according to claim 14, characterized in that the radial port comprises at least one radial fin which, considered in cross-section in a plane perpendicular to the longitudinal axis, is inclined with respect to the radial direction, and in that the axial fin, considered in cross-section in a plane perpendicular to the longitudinal axis, is inclined with respect to the radial direction in the same sense as the radial fin.

17. The alternator according to claim 11, characterized in that the radial fins have, perpendicular to their profile, a section of constant size.

18. The alternator according to claim 11, characterized in that the radial fins have, perpendicular to their profile, a section of variable size along this profile.

19. The alternator according to claim 18, characterized in that the fins have a curved profile.

20. The alternator according to claim 11, characterized in that at least one of the fins of at least one of the axial and radial ports has an edge turned towards the fan inclined so that the edges of the blades of the fan turned towards said port progressively sweep across said edge of the fin while turning about the rotary shaft.
